(19) United States
(12) Patent Application Publication
(10) Pub. No.: US 2012/0112904 A1
(43) Pub. Date: May 10, 2012

(54) System and Method for Tracking, Monitoring and Deriving the Location of Transient Objects by Monitoring the Location of Equipment Used to Move the Objects

(75) Inventor: Vincent I. Nagy, Aliquippa, PA (US)

(73) Assignee: HAMMEL COMPANIES, INC., Pittsburgh, PA (US)

(21) Appl. No.: 12/941,542

(22) Filed: Nov. 8, 2010

(51) Int. Cl. G08B 1/08

(52) U.S. Cl. 340/539.13

(57) ABSTRACT

System and method combining a Dock Automation (“DA”) system with a Real Time Locating System (“RTLS”) to achieve automated accuracy relating to the location of shipment components. An RTLS system is used to track the position of assets which move shipment components over time. When any action is performed on a shipment component in the DA system, the time of the action and the RTLS device ID of the asset (piece of equipment or person) performing the action would be used in conjunction with the RTLS database, providing the location at which the event took place. Knowing the location of the asset performing an action on a component implies knowing the location of the component being acted upon. At any time, the component should be wherever the last asset interacted with it.

### FIELD OF THE INVENTION

The present invention is directed toward tracking, monitoring and locating transient objects such as, for example, shipment components and, more particularly, toward a system and method for tracking, monitoring and locating transient objects by monitoring the location of equipment used to move the objects.

### BACKGROUND OF THE INVENTION

A Dock Automation system (“DA system”) generally refers to a collection of software and hardware components employed to track and manage vehicles, trailers, trailer contents, etc. as they approach and depart a dock, as well as assign and/or record the work of moving of transient items (typically shipments, which in turn are made up of components) across the dock space or area from trailer to trailer.

For example, as a trailer is placed at an unload door, it is entered into the DA system as ready to unload. As items are removed from the trailer, they are scanned so the DA system knows they are unloaded from the trailer and on the dock. As items are loaded into a truck or trailer, they are again scanned so the DA system knows they have left the dock and are loaded. However, with just that much information, the DA system cannot tell where on the dock the shipment is while it is still on the dock. It can't know if an item or component is in transit from a door to another door, or where it is stored if it needs to be stored for a period of time before being loaded on a trailer.

One solution to tracking and locating shipments on a dock has been to have the dock workers manually log the location of the shipment they are handling. This entry has traditionally been performed by workers using handheld computers, into which location IDs can be entered, or with which location ID tags (e.g., barcodes) mounted at fixed points on the dock can be scanned. However, there are innate weaknesses with manual entry. Those weaknesses fall into two general categories: accuracy and efficiency.

Regarding accuracy, manual data entry can be prone to errors. A worker can transpose numbers when entering a location ID, or simply input or scan a wrong or incorrect location ID. It could be difficult, if not impossible, for the DA system to detect such an error and, therefore, the incorrect data will be allowed to propagate throughout the DA system.

Regarding efficiency, the act of scanning or entering location IDs causes extra time to be added to every shipment/component move. Manual keying data takes time, and requires the user to look at the device as opposed to looking at their surroundings. In cold weather, it might also necessitate the removal of gloves.

Scanning can add two types of inefficiency. First, it is unlikely that the location ID tag will be exactly where the component is placed. If a tag identifies a bay area, for instance, it represents a location roughly the size of a trailer. Bays are by nature open spaces away from pillars and walls, and therefore do not have convenient places to put a scanable location ID tag. Utilizing ceiling mounted hanging barcode signs would require the use of expensive long range scanners, and the signs themselves could interfere with or be blocked by tall or stacked shipments or components. The most likely location for a bay's location ID tag to be placed would be near that bay's corresponding door.

So when the user arrives at the bay, time will be taken to travel to the tag, to scan the tag, then to move to the location in the bay at which the component is placed. This adds a previously unneeded stop to perform the scan, extra travel time to get from the tag to the actual location, and possibly an extra direction change of the vehicle or equipment performing the move. All this represents time loss and equipment wear. The inefficiencies associated with this back and forth travel are obvious.

Yet another drawback is that there is always the chance that a user could accidentally scan the wrong barcode for a move. For example, assume there is a shipment in the bay waiting to be picked up for transport. The user may inadvertently scan the barcode for the door instead of the barcode for the bay when the shipment is picked up for loading into a trailer. The DA system typically will not have any checks preventing this, as the door would be just as valid for a destination as the bay, but the error would make the trailer manifest incorrect.

Other DA systems employed may utilize item level RFID tags. Each shipment would get its own RFID tag and those tags would be sensed by receivers/readers positioned throughout the dock. There are various drawbacks to applying an RFID tag to each shipment. The cost of tagging all items is expensive, from both an equipment and labor cost standpoint. Since the tags will be placed on various kinds of materials, there is a challenge in obtaining acceptable read rates for all of the various kinds of materials. The cost and complexity associated with installing sufficient receivers/readers to minimize overlap yet still provide meaningful dock coverage. And the data horsepower required to process all of the RFID tags and they pass by the receivers/readers is not insignificant, as a lot of data would need to be processed to obtain meaningful information.

The present invention is directed toward overcoming one or more of the above-mentioned problems.

### SUMMARY OF THE INVENTION

A “Real Time Location System” (“RTLS”) generally refers to a collection of software and hardware components employed in providing visibility into the current location of objects in 2-dimensional space. The objects being tracked can be anything to which a RTLS beacon (such as an RFID tag or other wireless transmitter) can be attached. For example, RTLS has been used to track people in office buildings, students on campuses, and critical equipment in hospitals. RTLS can operate in a strictly instantaneous mode, providing only the current location of tracked items. It can also be used in conjunction with a database which accumulates location information over fixed intervals of time, allowing for the accumulation of path, rate of travel, and time in motion data to be calculated and stored. For the purposes of the present invention, RTLS is used to track the location and the movement of any person or piece of equipment (assets) that acts on and changes the location of the transient components on, for example, a dock. For instance, the last twenty-four continuous hours of the travels of forklifts could be monitored and stored.

The unique proposed solution combines the DA system with the RTLS system to achieve automated accuracy relating to the location of shipment components. An RTLS system is used to track the position of assets which move shipment components over time. When any action is performed on a shipment component in the DA system, the time of the action and the RTLS device ID of the asset (piece of equipment or person) performing the action would be used in conjunction with the RTLS database, providing the location at which the event took place. Knowing the location of the asset performing an action on a component implies knowing the location of the component being acted upon. At any time, the component should be wherever the last asset interacted with it.

An example scenario could start with the operator of a forklift lifting a component. The operator signals the computer the act of lifting a component. As the operator scans, or otherwise inputs, the ID of the component being lifted, the RTLS would provide to the DA the location of the forklift and, therefore, the location of the pickup. If that action happens inside an unloading trailer, the component would be logged as removed from the trailer. The forklift would then travel along the dock to the destination location specified by the DA for the component. Upon arriving at the location, the operator will signal the computer the act of putting the component down. If the RTLS sees the component is placed in a trailer, the correctness of the load can be verified by the DA, and the component added to that trailer's manifest. If the component is placed in a bay, the RTLS will save the derived location of that component. This location information can be used by DA to direct further actions on that component, insuring it is eventually placed in the correct trailer.

In one form, a method of tracking a location of an object is provided, including that steps of providing a plurality of receivers covering a predefined area to be monitored, providing wireless transmitters on equipment used within the predefined area to move objects, monitoring movement of the equipment within the predefined area via the wireless transmitters and receivers, providing, by a piece of equipment, a signal indicative of an action performed on an object by the piece of equipment, and identifying a location of the object based on the monitored location of the piece of equipment at the time of performing the action. The identified location of the object is stored in a database so the location is known for future reference.

The signal indicative of an action performed on an object is typically a signal indicative of either picking up or putting down the object.

In another form, a system for tracking a location of an object is provided, including a plurality of receivers positioned about a predefined area to be monitored, wireless transmitters provided on each piece of equipment used within the predefined area to move objects, the wireless transmitters transmitting signals received by the plurality of receivers, and a main computer including a processor receiving the wireless transmitter signals from the plurality of receivers and monitoring movement of the equipment within the predefined area, wherein upon picking up an object to be moved, a user of a piece of equipment transmits an identification of the object and a pick up command to the main computer, the main computer identifying the location of the piece of equipment at the time of issuing the pick up command as a first location of the object, and wherein upon placing down the object moved, the user of the piece of equipment transmits a put down command to the main computer, the main computer identifying the location of the piece of equipment at the time of issuing the put down command as a second location of the object.

The system further includes a database storing the first and second locations of the object. Since the second location is associated with putting down the object, the second location is stored as a current location of the object. By monitoring the location of pieces of equipment acting on the object, the location of the object may be tracked.

In a further form, a method of tracking a location of an object is provided, including the steps of providing a plurality of receivers covering a predefined area to be monitored, providing wireless transmitters on equipment used within the predefined area to move objects, monitoring movement of the equipment within the predefined area via the wireless transmitters and receivers, upon picking up an object to be moved, transmitting, by a piece of equipment, a signal indicative of picking up the object, storing, in a database, a location of the piece of equipment at the time of transmitting the pick up signal as a first location of the object, upon putting down the object moved, transmitting, by the piece of equipment, a signal indicative of putting down the object, and storing, in a database, a location of the piece of equipment at the time of transmitting the put down signal as a second location of the object.

In some instances, the second location (put down location) of an object will be known, such as where a dock worker is instructed to move an object to a certain location. If the location of the piece of equipment at the time of transmitting the put down signal is not the intended location of the object, a warning signal is sent to the operator of the piece of equipment.

The plurality of receivers may include a plurality of RFID receivers, and the wireless transmitters may include RFID tags. The RFID tags may include passive or active RFID tags.

The equipment may include motorized equipment, such as forklifts, etc., or persons.

It is an object of the present invention to provide a system and method for tracking the movement of objects by monitoring the location of equipment used to move the objects.

It is a further object of the present invention to provide a system and method for tracking the movement of objects requiring minimal manual operation.

It is yet a further object of the present invention to provide a system and method for tracking the movement of objects by combining aspects of DA and RTLS systems.

Other objects, aspects and advantages of the present invention can be obtained from a study of the specification, the drawings, and the appended claims.

### BRIEF DESCRIPTION OF THE DRAWINGS

FIG. 1 is a block diagram of the system of the present invention showing different objects to be moved, pieces of equipment equipped with wireless transmitters as tags used to move the objects, a plurality of receivers/readers and a main computer with a processor and database; and

FIGS. 2-4 are diagrams illustrating movement of an object within a predefined area in accordance with the inventive system and method.

### DETAILED DESCRIPTION OF THE INVENTION

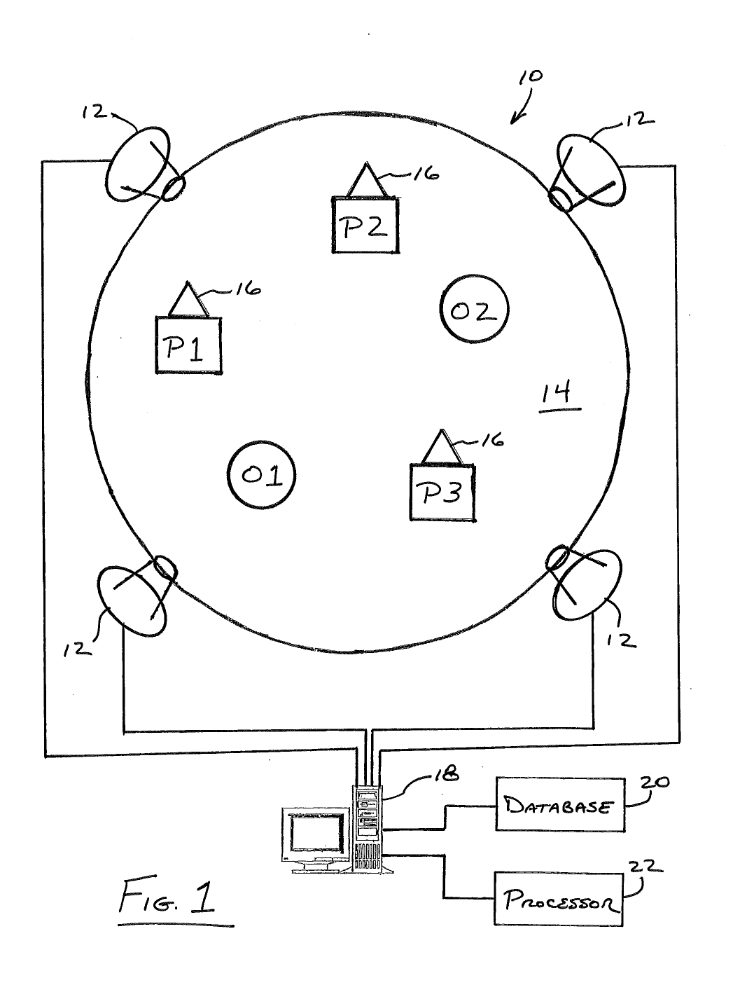

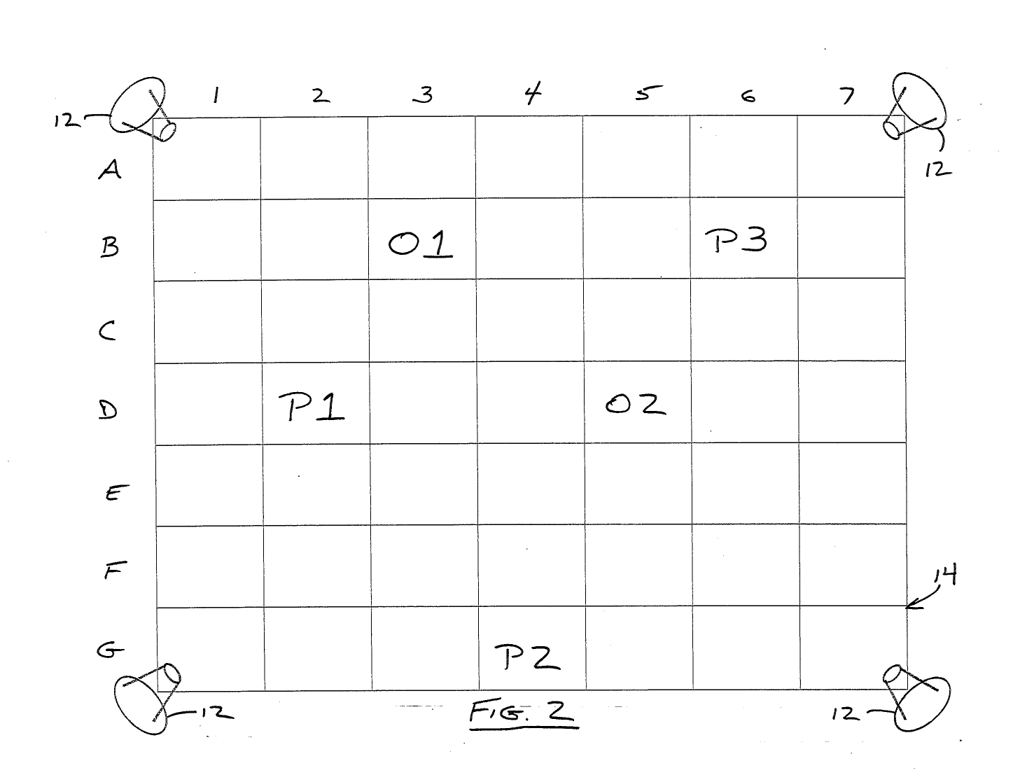

Referring to FIG. 1, a system for tracking, monitoring and deriving the location of transient objects is shown generally at 10. The system 10 includes a plurality of receivers or readers 12 placed about a predefined area 14 to be monitored. As used herein, the terms receiver and reader are used to denote the same or similar device. The predefined area 14 may be any area where transient objects are stored and their location needs to be monitored, such as, for example, a dock, a bay, a warehouse, etc. The receivers 14 should be placed such that they provide coverage for the area 14 to be monitored. While four receivers 12 are shown in FIGS. 1 and 2, any number may be implemented in accordance with the present invention.

Within the area 14 to be monitored, there are a number of objects O1, O2 which are to be moved and stored within the area 14. Pieces of equipment P1, P2, P3 are used to move the objects O1, O2 within the area 14. The pieces of equipment P1, P2, P3 may be motorized vehicles use to move objects and materials, such as, for examples, forklifts, loaders, lift trucks, etc., or may be persons who will pick up and move the objects and materials. Each piece of equipment P1, P2, P3 included a wireless tag transmitter 16 mounted thereon.

The tag transmitters 16 could be any transmitting device that transmits a signal announcing its identity. These include, but are not limited to, RFID tags (active and passive), beacons, 802.11 radios, high/low frequency tags, etc. It is known in the art to use tags/transmitters that are proprietary to the particular RTLS system being implemented. For instance, some systems may use their own radio beacon that does nothing but identify itself to the RTLS system, and the system derives the location of the beacon using a constellation of receivers. Other systems may utilize a constellation of locating beacons that an ID tag interrogates. The ID tag then sends it's ID and the some of information received back from the locating beacons back to a main processor. The use of high or low frequency tags will depend up the system being implemented. High frequency tags typically have better accuracy, while low frequency tags typically have better penetration and range.

Most RTLS systems are configurable to set how often a location tag reports it location or has its location reported. Typically, this is a trade off with battery life. A tag that only updates its location when it stops moving or is asked to update its location, will have a much longer battery life than one that transmits a signal every couple of seconds. This update frequency will depend upon the particular requirements of the RTLS system being implemented.

Operation of the tag transmitters 16 can vary depending on the circuitry chosen. In one form, the tag transmitters 16 can transmit a pulse of radio frequency energy that is encoded with information announcing the identity of the piece of equipment P1, P2, P3 to which it is attached and possibly other data and/or information stored in a memory (not shown) in the tag transmitter 16. Typically, a timing marker will precede the pulse as a preamble. The tag transmitters 16 transmit their identification signals continuously or at predetermined intervals.

The receivers 12 are operatively connected to a main computer 18, which includes a database 20 and processor 22. The receivers 12 receive the wireless signals transmitted by the tag transmitters 16 and feed them to the main computer 18. The main computer 18, via the processor 22, processes the received signals according to known RTLS processing techniques to determine the location of the equipment P1, P2, P3 at any given time. The results can be stored in the database 20 in order the track the movement of the equipment P1, P2, P3. There are various RTLS implementations currently in existence which could be utilized in accordance with the present invention. By way of example only, some of the paradigms include using:
Existing 802.11 network infrastructure to triangulate devices on the network.
An array of reference location tags to correlate the location of the device (piece of equipment) in question.
An array of receivers to compare relative time delay of a reflected signal, or one generated on command.

Technologies used as beacons or transmitters on the user or the user's equipment might include passive or active RFID tags, or vendor proprietary beacons. Or, in the 802.11 scenario, the very radio used to communicate on the network might provide the localizing signal.

Some example RTLS solutions include:
Mojix created an RTLS system based on passive RFID tags. The Mojix RTLS system works by having one transmitter send a signal that energizes all of the tags in its space. An array of receivers provided about the area to be monitored then “listen” for the tag's echo, and triangulate the tag's location.
UBIsense created an RTLS system based on active Ultra Wide Band beacons which broadcast signals to be received by an array of receivers provided about the area to be monitored. These receivers can resolve a 3-dimensional location with as few as two receivers using Angle of Arrival and Time Difference of Arrival algorithms.
RFind created an RTLS system that operates using proprietary beacons and an array of reference tags. When a beacon stops moving, it sends a request to any reference tags in the area. The reference tags respond with the exact time they received the request. The beacon then sends it's ID plus the set of information it received to a main computer which uses that data to perform the triangulation.

As will be understood by those skilled in the art, many different RTLS approaches can be implemented without departing from the spirit and scope of the present invention. The determining factors for their appropriateness for an RTLS system in a DA application include, but are not limited to:
Sufficient resolution: The minimum resolution for the system must be no more than half the width of a trailer door when the system is implemented in a dock environment. Otherwise the system could report a package's placement in the incorrect trailer, providing inaccurate information to the DA.
Sufficient reporting interval: As noted, the tags be locatable while in motion as well as when stationary. In practice, a forklift can stop, put down a package, and resume motion in as little as two seconds. An RTLS system would need to not report location so infrequently as to miss the correct location of the drop.

Referring to FIGS. 2-4, the operation of the inventive system and method for tracking the movement of transitory objects will now be described. As shown in FIG. 2, the predetermined area 14 to be monitored is divided into sections. For convenience, FIG. 2 divides the area into a grid. Objects O1, O2 to be moved are illustrated in FIG. 2, as well as equipment P1, P2, P3 used to move the objects O1, O2. Object O1 is at location B3. Object O2 is at location D5. Equipment P1 is at location D2. Equipment P2 is at location G4. Equipment P3 is at location B6.

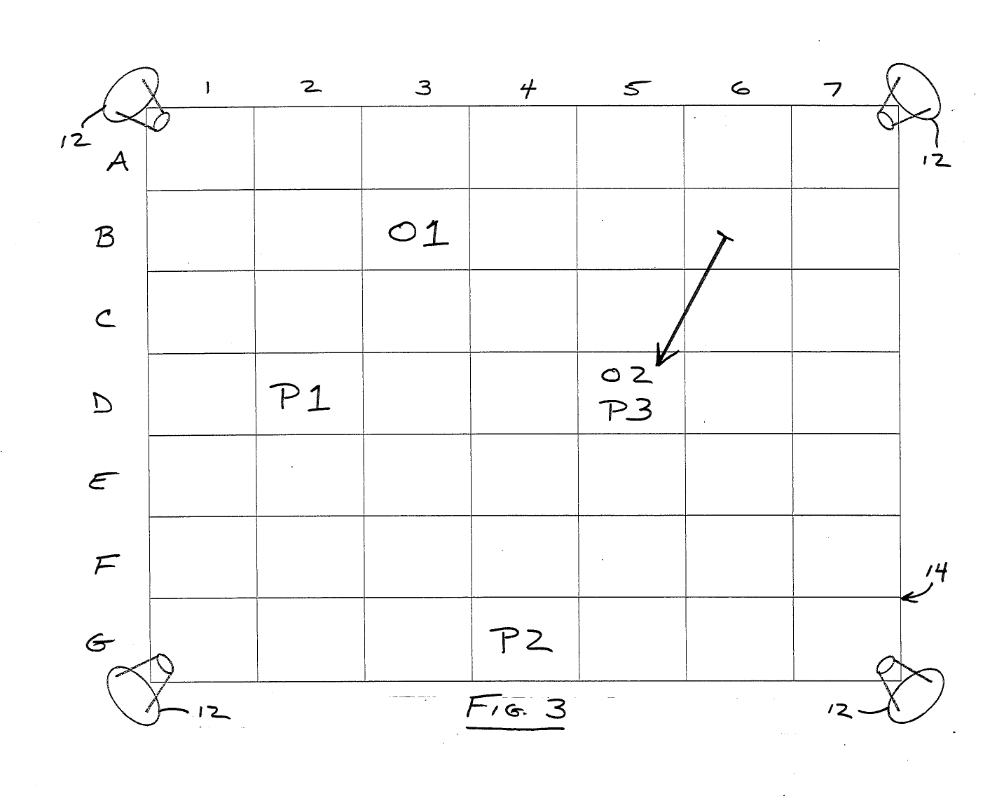

FIG. 3 illustrates that equipment P3 has moved into location D5. The user of equipment P3 will transmit a signal that is it “picking up” object O2. This signal is transmitted via conventional DA signaling techniques and may be a wireless signal that is received by the receivers 12 or other receivers positioned about the area 14. The signal includes an identification of object O2, which may be input manually by the user or the user can scan a barcode attached to the object. This signal is received by the main computer 18, which also knows the location of equipment P3 via the RTLS technology (e.g., wireless transmitters 16 and receivers 12) implemented to monitor the location of the equipment P1, P2, P3. Thus, the system knows that the action of moving object O2 began in location D5. If data already exists in the system regarding the location of object O2, that data can now be updated to indicate that object O2 is “in transit”.

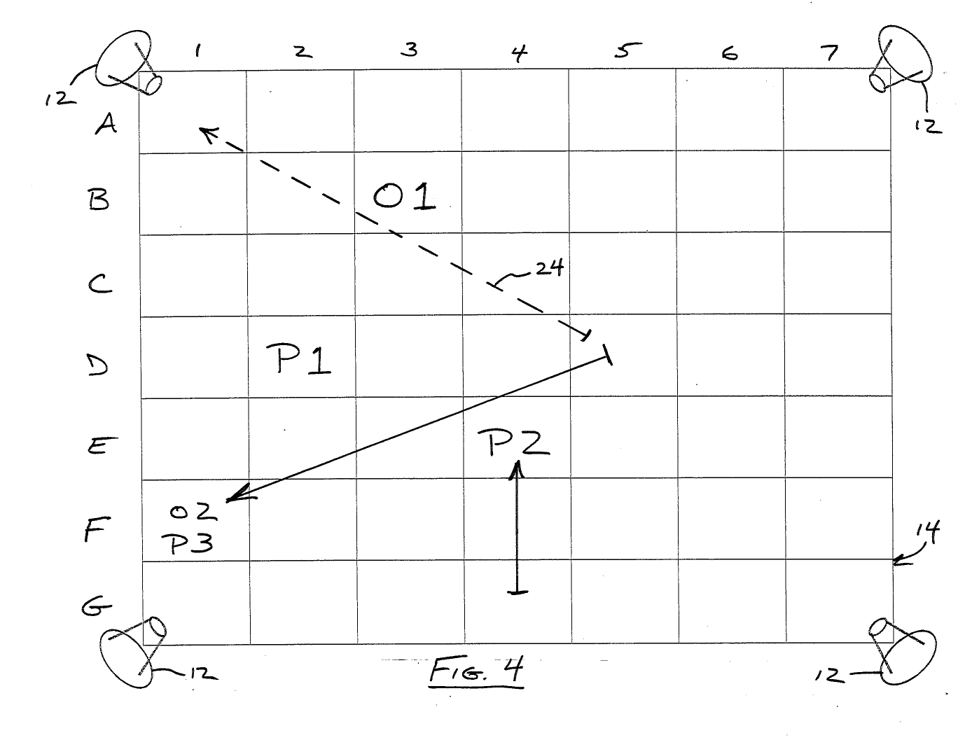

FIG. 4 illustrates the equipment P3 have moved object O2 to location F1. The user of equipment tells the system that they are “putting down”. Since the system already knows the identity of object O2 as the object being moved, there is no need to re-enter that data. The signal is received by the main computer 18, which also knows the location of equipment P3 via the RTLS technology. The current location of object O2 is then recorded in the database 20 as location F1. Additionally, the system sees that equipment P2 has moved from location G4 to E4, and also records that as the current location of equipment P2.

It is not sufficient for the system to simply respond with the instantaneous location of object O2 at the time of the “putting down” signal. The system needs to track the continuing movement of object O2, in the event the equipment P3 moves out of the sensing area 14. For example, if a trailer was located at position F0 (possibly outside the sensing grid 14), the system will have to have seen the user (equipment P3) travel into location F1 and then “disappear”. The assumption can then be made that the user (equipment P3) went into location F0, as any other direction would still be visible in the grid 14. The “reappearance” of the equipment P3 at location F1 can be used as further validation. Any inconsistencies of path, like, for example, equipment P3 disappearing at location F1 and then reappearing at, for example, location G1 can be flagged as a potential problem by the system, and an appropriate warning sent to managing personnel.

Additionally, the system 10 of the present invention can be used to track the instantaneous location of an object to ensure that it is being delivered to the correct destination. For example, in FIGS. 2-4 assume that the user/operator of equipment P3 was instructed to move object O2 to location A1. Upon receiving the signal that equipment was “putting down” object O2 in location F1, the system 10 can send a warning signal to the operator of equipment P3 that the “put down” location is not the intended location of object O2.

Further still, the route of the equipment can be tracked as it is moving the objects and early warning signals sent to the operators. Assume again that in FIGS. 2-4 the user/operator of equipment P3 was instructed to move object O2 to location A1. The system would know the correct traveling route from D5 to A1, which is shown as dotted line 24 in FIG. 4. Upon tracking the location of equipment P3 and seeing it in location E3 (as equipment P3 moves from location D5 to location F1), the system can send a warning signal to the operator of equipment P3 that they are traveling in the wrong direction.

The present invention combines RTLS technology into a DA system for the purpose of using data from an RTLS system tracking the location of people and equipment/assets moving “objects” (e.g., items making up shipments, or packages) to derive the location of those objects. By combining functionalities of the RTLS and DA systems, the inventive system is able to “know” the location of every shipment package with sufficient resolution to be able to report its location on the dock floor, or the event of its being loaded on a trailer. This information can be used to allow the inventive system to insure the accuracy and completeness of the loads going into trailers, and to help users locate missing packages on the dock.

While the present invention has described herein with particular reference to the drawings, it should be understood that various modifications could be made without departing from the spirit and scope of the present invention. Those skilled in the art will appreciate that various other modifications and alterations could be developed in light of the overall teachings of the disclosure. For example, the present invention has been described herein utilized on a dock floor for tracking shipments as they are loaded, possibly stored, and then loaded. However, the present invention may be implemented in other environments, such as, but not limited to, a warehouse environment, where the location and/or tracking of objects is desired. The presently preferred embodiments described herein are meant to be illustrative only and not limiting as to the scope of the invention which is to be given the full breadth thereof.

I/we claim:

1. A method of tracking a location of an object comprising the steps of:
providing a plurality of receivers covering a predefined area to be monitored;
providing wireless transmitters on equipment used within the predefined area to move objects;
monitoring movement of the equipment within the predefined area via the wireless transmitters and receivers;
providing, by a piece of equipment, a signal indicative of an action performed on an object by the piece of equipment; and
identifying a location of the object based on the monitored location of the piece of equipment at the time of performing the action.

2. The method of claim 1, wherein the signal indicative of an action performed on an object is selected from the group consisting of picking up and putting down the object.

3. The method of claim 1, wherein the plurality of receivers comprises a plurality of RFID receivers, and wherein the wireless transmitters comprise RFID tags.

4. The method of claim 3, wherein the RFID tags comprise passive or active RFID tags.

5. The method of claim 1, further comprising the step of storing the identified location of the object in a database.

6. The method of claim 1, further comprising the steps of:
upon picking up an object to be moved, transmitting, by a piece of equipment, a signal indicative of picking up the object;
identifying the location of the piece of equipment at the time of transmitting the pick up signal as a first location of the object;
transporting, by the piece of equipment, the object from the first location to a second location;
upon putting down the object moved, transmitting, by the piece of equipment, a signal indicative of putting down the object; and
identifying the location of the piece of equipment at the time of transmitting the put down signal as the second location of the object.

7. The method of claim 6, further comprising the step of storing movement of the object from the first location to the second location in a database.

8. The method of claim 1, wherein the equipment comprises motorized equipment.

9. The method of claim 1, wherein the equipment comprises persons.

10. A system for tracking a location of an object comprising:
a plurality of receivers positioned about a predefined area to be monitored;
wireless transmitters provided on each piece of equipment used within the predefined area to move objects, the wireless transmitters transmitting signals received by the plurality of receivers; and
a main computer including a processor receiving the wireless transmitter signals from the plurality of receivers and monitoring movement of the equipment within the predefined area,
wherein upon picking up an object to be moved, a user of a piece of equipment transmits an identification of the object and a pick up command to the main computer, the main computer identifying the location of the piece of equipment at the time of issuing the pick up command as a first location of the object, and
wherein upon placing down the object moved, the user of the piece of equipment transmits a put down command to the main computer, the main computer identifying the location of the piece of equipment at the time of issuing the put down command as a second location of the object.

11. The system of claim 10, further comprising a database storing the first and second locations of the object.

12. The system of claim 11, wherein the second location is stored as a current location of the object.

13. The system of claim 10, wherein the plurality of receivers comprises a plurality of RFID receivers, and wherein the wireless transmitters comprise RFID tags.

14. The method of claim 13, wherein the RFID tags comprise passive or active RFID tags.

15. The method of claim 10, wherein the equipment comprises motorized equipment.

16. The method of claim 10, wherein the equipment comprises persons.

17. A method of tracking a location of an object comprising the steps of:
providing a plurality of receivers covering a predefined area to be monitored;
providing wireless transmitters on equipment used within the predefined area to move objects;
monitoring movement of the equipment within the predefined area via the wireless transmitters and receivers;
upon picking up an object to be moved, transmitting, by a piece of equipment, a signal indicative of picking up the object;
storing, in a database, a location of the piece of equipment at the time of transmitting the pick up signal as a first location of the object;
upon putting down the object moved, transmitting, by the piece of equipment, a signal indicative of putting down the object; and
storing, in a database, a location of the piece of equipment at the time of transmitting the put down signal as a second location of the object.

18. The method of claim 17, wherein if the location of the piece of equipment at the time of transmitting the put down signal is not the intended location of the object, sending a warning signal to an operator of the piece of equipment.

19. The method of claim 17, wherein the plurality of receivers comprises a plurality of RFID receivers, and wherein the wireless transmitters comprise RFID tags.

20. The method of claim 17, wherein if the monitored movement of the piece of equipment as it moves the object is not along a route to an intended destination of the object, sending a warning signal to an operator of the piece of equipment.
